(19) United States
(12) Patent Application Publication
(10) Pub. No.: US 2008/0078353 A1
(43) Pub. Date: Apr. 3, 2008

(54) Connecting rod for internal combustion engine

(75) Inventor: Kenji Hayama, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 11/902,682

(22) Filed: Sep. 25, 2007

(30) Foreign Application Priority Data
Sep. 29, 2006 (JP) 2006-266654

(51) Int. Cl. F16C 7/00

(52) U.S. Cl. 123/197.3

(57) ABSTRACT

A connecting rod may include a through-hole formed in the skirt. The through-hole is disposed at a region of the relative movement of the big end to the crank pin (an upstream rotation region). Accordingly, the load transmission between the bearing shell and the crank pin at the upstream rotation region in the combustion stroke of the engine is restricted, thereby achieving the sufficient oil film thickness on the region.

This disclosure of Japanese Patent Application No. 2006-266654 filed on Sep. 29, 2006, including the specification, drawings, and abstract is incorporated by reference in its entirety.

### BACKGROUND OF THE INVENTION

1. Field of the Invention

The present invention relates to a connecting rod adapted to an internal combustion engine, such as a vehicle engine. More particularly, the present invention improves lubrication between the big end of a connecting rod and the crankshaft.

2. Description of the Related Art

As described in Japanese Patent Application Publication No. 2000-179535 (JP-A-2000-179535) and Japanese Patent Application Publication No. 2001-18056 (JP-A-2001-18056), a conventional internal combustion engine, such as a vehicle engine, is configured such that a piston and a crankshaft are connected by a connecting rod so that explosive power of the gas mixture in a combustion stroke is transmitted to the crankshaft through the piston and the connecting rod.

As shown in FIG. 9, a connecting rod generally includes a small end b on a piston side, a big end c on a crankshaft side, and a column d which connects the small end b and the big end c. The small end b is formed with a piston pin hole b1 through which a wrist pin is inserted to connect the piston e (shown by an imaginary line in FIG. 9). The big end c is formed with a crank bearing hole c1 through which a crank pin f of the crankshaft is inserted. The big end c is configured to be divided into a body c2 and a cap c3. Semicircular-shaped bearing shells g are respectively provided on the inner surfaces of the body c2 and the cap c3 of the big end c. When the crank pin f is inserted through the crank bearing hole c1 formed between the body c2 and the cap c3 of the big end c, the body c2 and the cap c3 are coupled by cap bolts h.

Because the connecting rod a transmits the explosive power of the gas mixture, it is required to have high rigidity. Further, because the connecting rod a moves at a high speed (the small end b reciprocates, and the big end c revolves), it is required to be lightweight. For the lightweight connecting rod a, the column d is typically formed to have an I-shaped or H-shaped cross section, which is symmetric about an axis line of the column d.

According to the recent tendency to increase speed and power of vehicle engines, the big end c and the crank pin f of the crankshaft perform a sliding motion at a high speed and with a large load. Therefore, the big end c and the crank pin f of the crankshaft must have adequate lubrication therebetween.

In order to achieve sufficient lubrication, lubricant oil is supplied between the bearing shells g and the crank pin f. When the lubricant oil is provided between the bearing shells g and the crank pin f, the thickness of the lubricant oil film must be greater than a predetermined value. A critical situation for securing the lubricant oil film thickness may be when explosive power of the gas mixture, in a combustion stroke of the engine, is exerted on the connecting rod a from the piston e. In effect, the explosive power presses the bearing shell g of the body c2 of the big end c against the outer peripheral surface of the crank pin f. Accordingly, with respect to the lubrication, it is very important to form a lubricant oil film of sufficient thickness at the bearing shells g and g and the crank pin f and their neighboring portions.

In conventional connecting rod designs, a portion from the column d to the big end c (hereinafter, it will be called a skirt i) is shaped so that the mean value of stress applied to an overall contacting surface between the bearing shell g and the crank pin f in the combustion stroke of the engine is lower than a predetermined value. Describing in detail, in the combustion stroke of the engine, based on an area A of a projected plane between the bearing shell g and the crank pin f when viewing the big end c of the connecting rod a from the piston e (along the direction of action of the explosive power (shown by an arrow F in FIG. 9)) and a load F exerted on the connecting rod a, the skirt i is designed such that the mean value of the stress (F/A) applied to the overall projected plane is lower than a predetermined value. For example, the mean value of the stress may be reduced below the predetermined value by increasing the cross-sectional area of the skirt i, the diameter of the crank bearing hole C1 and the diameter of the crank pin f.

However, the above conventional method of designing the connecting rods has the following problems.

In the combustion stroke of the engine, the load is not exerted uniformly on the overall projected plane between the bearing shell g and the crank pin f when viewing the big end c of the connecting rod a from the piston e. In other words, as shown in FIG. 10 (which is a graph showing the load exerted on the projected plane defined as a circular arc surface from a point X to a point Y in FIG. 9), the greatest load (peak load) F1 is exerted on the axis line L of the connecting rod a, and the load decreases gradually as it goes away from the axis line L. Accordingly, the oil film thickness on the axis line L of the connecting rod a becomes particularly thin.

Also, in the combustion stroke, the peak load F1 on the axis line L varies according to the rotational position of the crankshaft. As shown in FIG. 9, the timing when the peak load F1 increases to the maximum (the timing when the oil film thickness on the axis line L decreases to the minimum) is when the piston e advances from a top dead center by a certain crank angle (in the range about from ten to twenty degrees). This is because combustion pressure in a combustion chamber is maximized at the above timing.

When the crankshaft further rotates from this state (the timing when the peak load F1 is maximized), because the bearing shell g and the crank pin f rotate relatively to each other, the oil film between the bearing shell g and the crank pin f, which is located at a portion opposite to the movement of the big end c, i.e., a left portion from the axis line L in FIG. 9 (more particularly, a portion of the relative movement of the bearing shell g to the crank pin f), is pressed to failure. Because it is difficult to form the oil film, and the oil film thickness becomes thin, sufficient lubrication cannot be achieved. FIG. 11 is a schematic diagram illustrating the oil film thickness formed between the bearing shell g and the crank pin f.

As described above, the load F exerted between the bearing shell g and the crank pin f is maximized on the axis line L, and decreases gradually as it goes away from the axis line L (refer to FIG. 10). In addition, by the rotational motion (the relative movement of the bearing shell g to the crank pin f in the combustion stroke), the oil film thickness on every point is affected such that the oil film thickness on the portion opposite to the movement of the big end c (the portion of the relative movement of the bearing shell g to the crank pin f; the left portion from the axis line L in FIG. 9) becomes extremely thin and the lubrication is insufficient.

One of reasons for this phenomenon is that the load exerted on the axis line L of the connecting rod a is excessively high. As described above, this phenomenon may be prevented by increasing the cross-sectional area of the skirt i and the diameter of the crank bearing hole c1 of the big end c to decrease the stress applied to the axis line L. However, this increases the weight of the connecting rod a and weight of the crankshaft. The increase in weight of the connecting rod and the crankshaft leads to deterioration in the starting performance of the engine, and increase in energy loss. As a result, the engine performance with high speed and high power deteriorates.

### SUMMARY OF THE INVENTION

The present invention optimizes the shape of the connecting rod a to increase the lubrication between the big end c and the crankshaft while satisfying the requirements of restricting the stress on every point due to the load applied thereto sufficiently low; setting a proper load peak point; decreasing the load applied to the load peak point; and avoiding an increase in weight of the connecting rod a or the crankshaft.

The present invention provides a connecting rod for an internal combustion engine that allows sufficient lubrication between the big end of a connecting rod and the crankshaft by improving the shape of the connecting rod.

In accordance with the present invention, by shaping the connecting rod asymmetrically such that the portion corresponding to the region between the big end of the connecting rod and the crank pin and the region, where the oil film thickness becomes thin in the combustion stroke of the internal combustion engine, has a lower rigidity than other portions, to thereby restrict the load transmission to the above region. And, by controlling the additional load that is transmitted to the region where the oil film is sufficiently formed, the oil film may be distributed evenly and sufficiently on every point.

In accordance with a first aspect of the present invention, a connecting rod for an internal combustion engine comprises: a small end coupled to a piston; a big end coupled to a crank pin; and a column provided between the small end and the big end. A region of the column or a region from the column to the big end is shaped such that the rigidity of a region of relative movement of the big end to the crank pin in a combustion stroke of the internal combustion engine with respect to an axis line of the connecting rod extending from a center point of the small end to a center point of the big end is lower than the rigidity of a region opposite to the relative movement. In other words, the rigidity at one side region from the axis line of the connecting rod (the region of the relative movement of the big end to the crank pin) is lower than the rigidity at the other side region from the axis line of the connecting rod (the region opposite to the relative movement of the big end to the crank pin).

Accordingly, the load transmission to the region which may have the problem that the oil film is thinner in a conventional combustion stroke of the engine (the region of the relative movement of the big end to the crank pin with respect to the axis line of the connecting rod) is restricted, and the pressing force of the big end (more particularly, the upper bearing shell) to the crank pin at the above region due to the explosive power (the load) of the gas mixture is reduced. Accordingly, the oil film can be formed on the above region with a sufficient thickness. On the other hand, most of the load is applied to the region opposite the relative movement of the big end to the crank pin with respect to the axis line of the connecting rod. However, because this region is the region where the oil film is originally formed with the sufficient thickness, the required oil film thickness is also achieved on this region. As a result, the lubrication between the big end of the connecting rod and the crank pin is improved.

In accordance with a second aspect of the present invention, a connecting rod for an internal combustion engine comprises: a small end coupled to a piston; a big end coupled to a crank pin; and a column provided between the small end and the big end. A region of relative movement of the big end to the crank pin in a combustion stroke of the internal combustion engine with respect to an axis line of the connecting rod extending from a center point of the small end to a center point of the big end is subjected to a process for reducing rigidity, and a region opposite to the relative movement is not subjected to the process for reducing rigidity.

In accordance with a third aspect of the present invention, a connecting rod for an internal combustion engine comprises: a small end coupled to a piston; a big end coupled to a crank pin; and a column provided between the small end and the big end. A region of the column or from the column to the big end is shaped to reduce rigidity. The extent of decreasing the rigidity at a region of relative movement of the big end to the crank pin in a combustion stroke of the internal combustion engine with respect to an axis line of the connecting rod extending from a center point of the small end to a center point of the big end is set higher than the extent of decreasing the rigidity at a region opposite the relative movement.

In accordance with a fourth aspect of the present invention, a connecting rod for an internal combustion engine comprises: a small end coupled to a piston; a big end coupled to a crank pin; and a column provided between the small end and the big end. A region of relative rotation of the crank pin to the big end in the combustion stroke of the internal combustion engine with respect to an axis line of the connecting rod, extending from a center point of the small end to a center point of the big end, is subjected to a process for increasing rigidity, and a region opposite to the relative rotation is not subjected to the process for increasing rigidity.

In accordance with a fifth aspect of the present invention, a connecting rod for an internal combustion engine comprises: a small end coupled to a piston; a big end coupled to a crank pin; and a column provided between the small end and the big end. A region of the column or from the column to the big end is shaped to increase its rigidity. An extent of increasing the rigidity at a region of relative rotation of the crank pin to the big end with respect to an axis line of the connecting rod, extending from a center point of the small end to a center point of the big end, is set higher than an extent of increasing the rigidity at a region opposite the relative rotation.

With the above configuration, the load transmission to the region of the relative movement of the big end to the crank pin with respect to the axis line of the connecting rod is restricted, thereby achieving the sufficient oil film thickness on the above region.

To decrease the rigidity, the region of the column or from the column to the big end may be formed with a through-hole or a recessed portion. Also, the region of the column or from the column to the big end may be shaped to have a narrow width from the axis line of the connecting rod.

On the other hand, to increase the rigidity, the region of the column or from the column to the big end may be formed with a large-thickness portion.

The recessed portion may be formed at a front surface and/or a rear surface extending in a direction perpendicular to a rotational axis of the crankshaft, or formed at a surface extending in a direction parallel with the rotational axis of the crankshaft.

In addition, to decrease the rigidity, the region of the column or from the column to the big end may be formed with a small-thickness portion to decrease the rigidity.

To decrease the rigidity, the region of the column or from the column to the big end may be shaped such that the thickness increases gradually toward the region opposite to the relative movement.

To decrease the rigidity, an edge portion of the column of the relative movement of the big end to the crank pin may be cut further inward than an edge portion opposite to the relative movement.

In accordance with a sixth aspect of the present invention, a connecting rod for an internal combustion engine comprises: a small end coupled to a piston; a big end coupled to a crank pin; and a column provided between the small end and the big end. The connecting rod is formed asymmetrically such that the rigidity or the rigidity-decreasing extent at a region of the column or from the column to the big end in a direction along which the big end moves relative to the crank pin in a combustion stroke of the internal combustion engine with respect to an axis line of the connecting rod, extending from a center point of the small end to a center point of the big end, is set to be lower than the rigidity or the rigidity-decreasing extent at a region in a direction opposite the direction.

In accordance with a seventh aspect of the present invention, a connecting rod for an internal combustion engine comprises: a small end coupled to a piston; a big end coupled to a crank pin; and a column provided between the small end and the big end. In order to decrease a load transmission to a region of relative movement of the big end to the crank pin in a combustion stroke of the internal combustion engine with respect to an axis line of the connecting rod extending from a center point of the small end to a center point of the big end lower than a load transmission to a region opposite to the relative movement, the connecting rod is shaped such that a load peak point in the combustion stroke is offset toward the region opposite to the relative movement with respect to the axis line of the connecting rod.

In order to restrict the load transmission to the region where the oil film is diluted between the big end of the connecting rod and the crank pin in the combustion stroke of the internal combustion engine, the connecting rod according to the present invention is shaped to be asymmetric such that a portion corresponding to the above region has a lower rigidity than other portions. Accordingly, the load transmission to the region of the relative movement of the big end to the crank pin with respect to the axis line of the connecting rod is restricted, thereby achieving the sufficient oil film thickness on the above region. As a result, the lubrication between the big end of the connecting rod and the crank pin can be enhanced considerably.

### BRIEF DESCRIPTION OF THE DRAWINGS

The present invention will become apparent from the following description of example embodiments, given in conjunction with the accompanying drawings, in which:

FIGS. 1A and 1B are views illustrating a connecting rod in accordance with a first embodiment of the present invention, FIG. 1A is a view of a connecting rod seen from a direction of a crank axis, and FIG. 1B is a sectional view taken along line IB-IB in FIG. 1A;

FIG. 2 is a graph that compares load distribution applied between a bearing shell and a crank pin in accordance with the present invention and load distribution applied between a bearing shell and a crank pin in accordance with the related art;

FIGS. 3A and 3B are views illustrating a connecting rod in accordance with a second embodiment of the present invention, FIG. 3A is a view of a connecting rod seen from a direction of a crank axis, and FIG. 3B is a sectional view taken along line IIIB-IIIB in FIG. 3A;

FIGS. 4A and 4B are views illustrating a connecting rod in accordance with a third embodiment of the present invention, FIG. 4A is a view of a connecting rod seen from a direction of a crank axis, and FIG. 4B is a sectional view taken along line IVB-IVB in FIG. 4A;

FIGS. 5A and 5B are views illustrating a connecting rod in accordance with a fourth embodiment of the present invention, FIG. 5A is a view of a connecting rod seen from a direction of a crank axis, and FIG. 5B is a sectional view taken along line VB-VB in FIG. 5A;

FIGS. 6A and 6B are views illustrating a connecting rod in accordance with a fifth embodiment of the present invention, FIG. 6A is a view of a connecting rod seen from a direction of a crank axis, and FIG. 6B is a sectional view taken along line VIB-VIB in FIG. 6A;

FIGS. 7A and 7B are views illustrating a connecting rod in accordance with a sixth embodiment of the present invention, FIG. 7A is a view of a connecting rod seen from a direction of a crank axis, and FIG. 7B is a sectional view taken along line VIIB-VIIB in FIG. 7A;

FIGS. 8A and 8B are views illustrating a connecting rod in accordance with a seventh embodiment of the present invention, FIG. 8A is a view of a connecting rod seen from a direction of a crank axis, and FIG. 8B is a sectional view taken along line VIIIB-VIIIB in FIG. 8A;

FIG. 9 is a view illustrating a conventional connecting rod seen from a direction of a crank axis;

FIG. 10 is a graph of load distribution applied between a bearing shell and a crank pin in the related art; and

FIG. 11 is a schematic diagram illustrating the oil film thickness formed between a crank pin and a bearing shell in the related art.

### DETAILED DESCRIPTION OF EMBODIMENTS

Various embodiments of the present invention will now be described in detail with reference to the accompanying drawings.

Hereinafter, embodiments of the present invention employed as a connecting rod in a reciprocating engine of vehicle will be described.

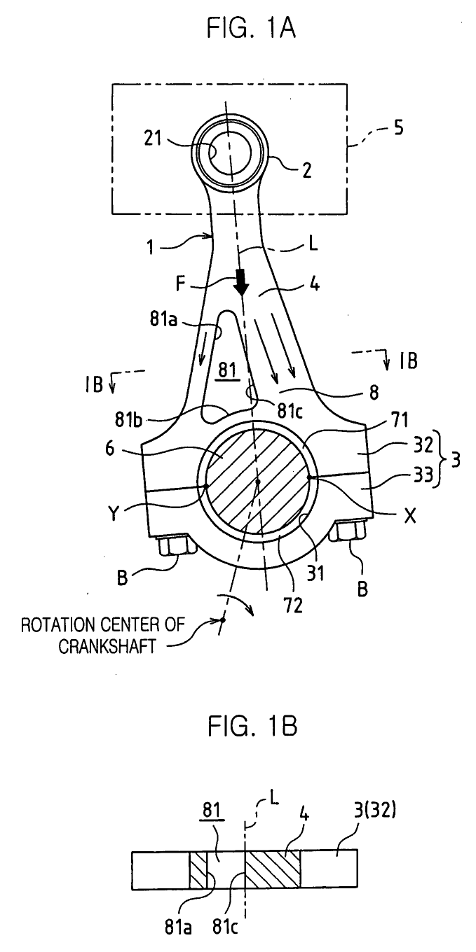

A first embodiment will now be described. FIG. 1A is a view illustrating a connecting rod 1 seen from a direction of the central axis of a crankshaft according to the first embodiment when a piston 5 advances from a top dead center by a certain crank angle of about ten to twenty degrees in the combustion stroke of an engine. In the drawing, the piston 5 is shown by an imaginary line. FIG. 1B is a sectional view taken along line IB-IB in FIG. 1A.

As shown in FIGS. 1A and 1B, because the essential elements of the connecting rod 1 according to this embodiment are substantially the same as the configuration of the related art, it will be described briefly.

The connecting rod 1 is formed by the, e.g., forging of carbon steel. The connecting rod 1 includes a small end 2 on the piston 5 side, a big end 3 on the crankshaft side, and a column 4 that connects the small end 2 and the big end 3. The connecting rod 1 may also be made from material, containing nickel-chrome steel, chrome-molybdenum steel, titanium alloy and the like

The small end 2 is formed with a piston hole 21 through which a wrist pin for connecting the piston 5 is inserted. The big end 3 is formed with a crank-bearing hole 31 through which a crank pin 6 of the crankshaft is inserted. The big end 3 is divided into a body 32 and a cap 33. A pair of upper and lower semicircular-shaped bearing shells 71 and 72 are respectively provided to the inner surfaces of the body 32 and the cap 33 of the big end 3. When the crank pin 6 is inserted through the crank bearing hole 31 formed between the body 32 and the cap 33 of the big end 3, the body 32 and the cap 33 are coupled by cap bolts B.

In other words, the connecting rod 1 connects the piston 5 and the crank pin 6 of the crankshaft. When the engine is operating, the piston 5 reciprocates in a cylinder (not shown) and the reciprocating motion is converted into the rotational motion of the crankshaft by the connecting rod 1. The rotational force is output as the engine power.

The crankshaft is formed with an oil supply path (not shown) through which lubricant oil is supplied to inner peripheral surfaces of the bearing shells 71 and 72. The lubricant oil supplied to the inner peripheral surfaces of the bearing shells 71 and 72 through the oil supply path forms an oil film between the bearing shells 71 and 72 and the crank pin 6 to provide lubrication between the bearing shells 71 and 72 and the crank pin 6. The bearing shells 71 and 72 are formed with recesses at their inner peripheral surfaces in a peripheral direction in order to retain the lubricant oil with the crank pin 6. The lubricant oil flows to the piston 5 through an oil passage (not shown) formed in the connecting rod 1 to provide lubrication between the piston pin and the piston.

According to the present invention the connecting rod 1 is shaped such that the load applied to the connecting rod 1 in the combustion stroke of the engine can be dispersed with a certain dispersion pattern. A detailed description thereof will now be provided.

As shown in FIGS. 1A and 1B, the connecting rod 1 of this embodiment has a through-hole 81 which is formed at the skirt 8 (the region from the column 4 to the big end 3) in an axial direction of the crankshaft (a direction parallel to the axis of the crank pin 6). The features of this embodiment lie on the position of the through-hole 81.

Describing in detail, the through-hole 81 is formed substantially as a triangular-shaped opening. The through-hole 81 is disposed at a region of the relative movement of the big end 3 to the crank pin 6 in the combustion stroke of the engine (more particularly, a region of the relative movement of the upper bearing shell 71 to the crank pin 6).

In other words, in the state of the combustion stroke depicted in FIG. 1A, explosive power F of gas mixture is supplied to the connecting rod 1 through the piston 5, and the big end 3 revolves around a rotational center of the crankshaft in a clockwise direction in the drawing. Also, the crank pin 6 follows the revolution of the big end 3 to revolve around the rotational center of the crankshaft in a clockwise direction in the drawing, and at the same time rotates on its own axis in a clockwise direction in the drawing. Therefore, as the crank pin 6 rotates on its own axis at the contacting surface between the upper bearing shell 71, provided to the inner surface of the body 32 of the big end 3, and the crank pin 6, the crank pin 6 performs a sliding motion in a clockwise direction relative to the bearing shell 71. In other words, the upper bearing shell 71 performs a sliding motion in a counterclockwise direction in the drawing relatively to the crank pin 6.

With respect to an axis line L of the connecting rod 1 (a straight line extending from a center point of the small end 2 to a center point of the big end 3), the through-hole 81 is primarily disposed at a region of the relative movement of the big end 3 to the crank pin 6 (a left portion from the axis line L in FIG. 1A). In the following description, a left region from the axis line L in FIG. 1A will be referred as an “upstream rotation region”, and a right region from the axis line L will be referred as a “downstream rotation region”.

Hereinafter, the position of the through-hole 81 will be described in detail. The through-hole 81 formed as a triangular-shaped opening has three sides 81a, 81b and 81c. One side 81a extends in substantially parallel with an outer edge of the skirt 8. Another side 81b extends with a circular arc shape along an inner periphery of the crank bearing hole 31. And, the other side 81c extends straight across the axis line L of the connecting rod 1.

Most of the through-hole 81 is formed in the upstream rotation region. Accordingly, the rigidity at the region over the column 4, the skirt 8 and the big end 3 in the upstream rotation region is set to be lower than the rigidity at the region over the column 4, the skirt 8 and the big end 3 in the downstream rotation region.

As a result, most of the load F applied to the connecting rod 1 in the combustion stroke of the engine is transmitted to the downstream rotation region, and the transmission of the load F to the upstream rotation region decreases (refer to arrows on the skirt 8 in FIG. 1A).

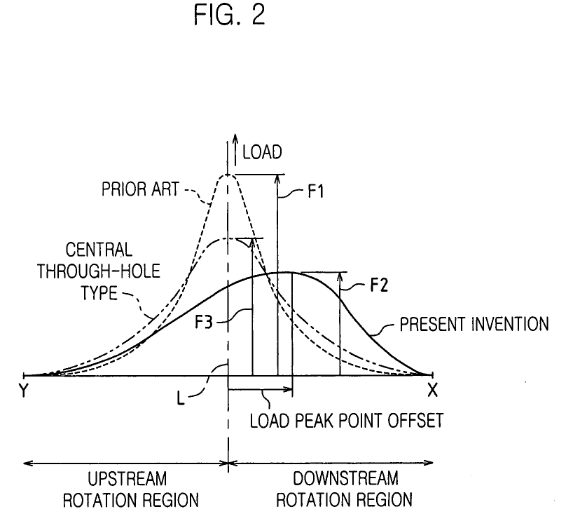

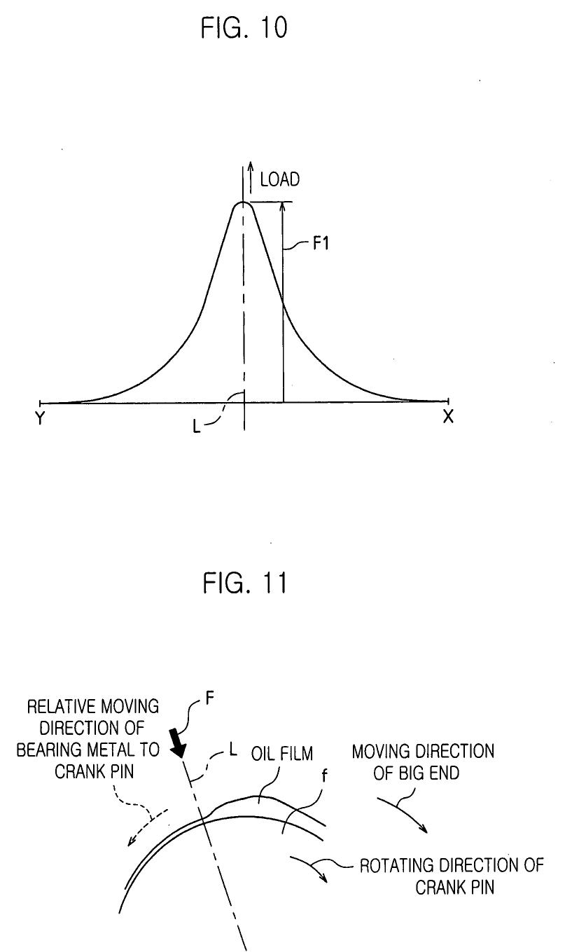

FIG. 2 is a graph of the load distribution in the combustion stroke of the engine, which is applied to every point of a projected plane between the upper bearing shell 71 and the crank pin 6 when viewing the big end 3 of the connecting rod 1 from the piston 5 (along the direction of action of the explosive power (shown by an arrow F in FIG. 1A)). At this time, the projected plane is defined as a circular arc surface from a point X to a point Y in FIG. 1A. A dotted line in the drawing refers to the load distribution on the related art connecting rod (the same graph as FIG. 10). A solid line in the drawing refers to the load distribution on the connecting rod 1 according to this embodiment. A double-dotted chain line in the drawing refers to the load distribution on the connecting rod 1 when the through-hole is formed at the middle of the skirt 8 symmetrically on the axis line L of the connecting rod 1.

As apparent from FIG. 2, in this embodiment, most of the load F applied to the connecting rod 1 is transmitted to the downstream rotation region. At this time, the load peak point is not located on the axis line L but offset to the right from the axis line L, so that the load transmission to the left region from the axis line L (i.e., the upstream rotation region) decreases considerably. As a result, in comparison with the load distribution on the related art connecting rod (refer to the dotted line in FIG. 2) and the load distribution on the connecting rod when the through-hole is formed at the middle of the skirt 8 (refer to the double-dotted chain line in FIG. 2), the load distribution in accordance with the this embodiment shows that the load applied onto the axis line L is considerably reduced. Furthermore, a load magnitude F2 at the load peak point in the load distribution in accordance with this embodiment becomes smaller than load magnitudes F1 and F3 at the load peak points in other load distributions. The graph illustrated in FIG. 2 has already been confirmed through a CAE analysis by the inventor(s) of the present invention.

As described above, the load transmission to the region where the thickness of the oil film is reduced in a conventional combustion stroke of the engine (the upstream rotation region) is restricted, and the pressing force of the big end 3 (more particularly, the upper bearing shell 71) against the crank pin 6 at the above region due to the explosive power F (the load) of the gas mixture is reduced. Accordingly, an oil film having sufficient thickness may be formed on the above region. On the other hand, most of the load is applied to the region opposite to the relative movement of the big end 3 to the crank pin 6 with respect to the axis line L of the connecting rod 1 (; the downstream rotation region). However, because this region is the region where the oil film is originally formed with sufficient thickness (refer to FIG. 11), the required oil film thickness can still be achieved in this region in this embodiment. Accordingly, the lubrication between the big end 3 of the connecting rod 1 and the crank pin 6 is improved enough to endure engine operation at high speed and power.

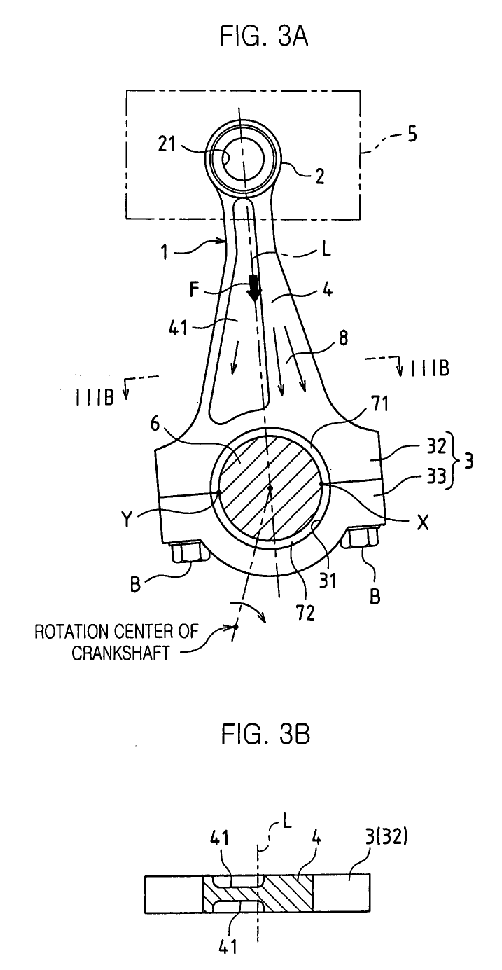

Hereinafter, a second embodiment will be described with reference to FIGS. 3A and 3B. FIG. 3A is a view illustrating the connecting rod 1 seen from the direction of the central axis of the crankshaft, and FIG. 3B is a sectional view taken along line IIIB-IIIB in FIG. 3A. The overall constitution of the connecting rod 1 according to this embodiment is the same as that of the first embodiment, except for the load dispersion constitution. Therefore, only the load dispersion constitution will now be described. The connecting rod 1 of this embodiment is formed to have an so-called I-shaped cross section and recessed portions 41 that are formed at front and rear surfaces of the column 4 (surfaces extending in a direction perpendicular to the rotational axis of the crankshaft).

The features of this embodiment lie on the position of the recessed portions 41.

Describing in detail, the recessed portion 41 is primarily disposed at the upstream rotation region (more particularly, the region of the relative movement of the upper bearing shell 71 to the crank pin 6). In other words, the recessed portion 41 is not formed near the downstream rotation region of the column 4. Accordingly, the rigidity at the region over the column 4, the skirt 8, and the big end 3 in the upstream rotation region is lower than the rigidity at the region over the column 4, the skirt 8, and the big end 3 in the downstream rotation region.

Although it is depicted in FIGS. 3A and 3B that part of the recessed portion 41 is formed at the downstream rotation region, the connecting rod 1 may be configured such that the recessed portion 41 is formed only at the upstream rotation region. Also, the depth of each recessed portion 41 is set to be about one third of the thickness of the column 4. However, the depth of the recessed portion 41 may widely change as long as the column 4 has a cross-sectional area large enough to transmit the explosive power.

Therefore, in this embodiment, most of the load F applied to the connecting rod 1 in the combustion stroke of the engine is transmitted to the downstream rotation region, and the load transmission to the upstream rotation region decreases (refer to arrows on the skirt 8 in FIG. 3A).

And, the load distribution applied to every point of a projected plane between the upper bearing shell 71 and the crank pin 6 in the combustion stroke of the engine is the same as that shown by the solid line in FIG. 2.

As described above, the load transmission to the region where the thickness of the oil film may be reduced in a conventional combustion stroke of the engine (the upstream rotation region) is restricted, and the pressing force of the big end 3 (more particularly, the upper bearing shell 71) against the crank pin 6 at the above region due to the explosive power F (the load) of the gas mixture is reduced. Accordingly, an oil film having sufficient thickness may be formed on the above region. On the other hand, most of the load is applied to the region opposite to the relative movement of the big end 3 to the crank pin 6 with respect to the axis line L of the connecting rod 1 (the downstream rotation region). However, because this region is the region where the oil film is originally formed with the sufficient thickness, the required oil film thickness can still be achieved in this region in this embodiment. Accordingly, the lubrication between the big end 3 of the connecting rod 1 and the crank pin 6 is improved enough to endure engine operation at high speed and power.

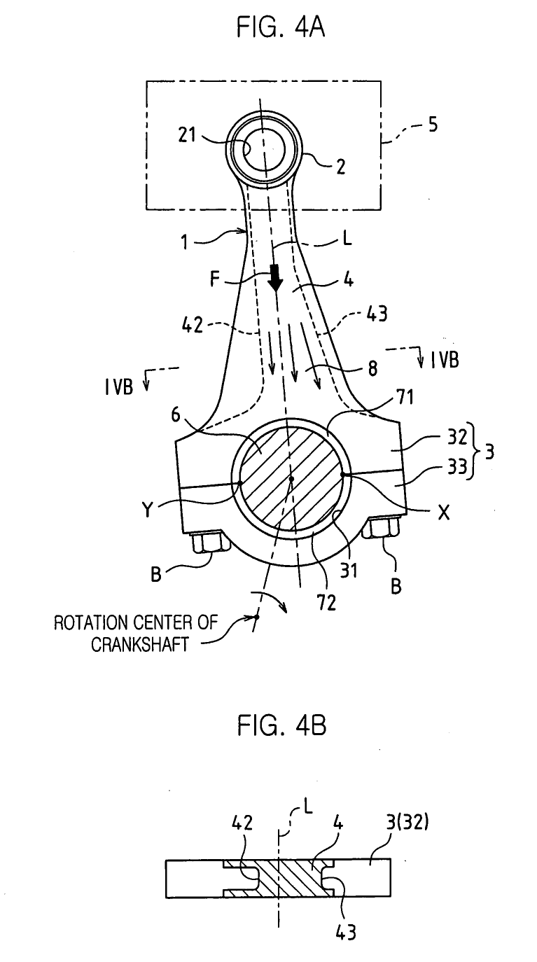

Hereinafter, a third embodiment will be described with reference to FIGS. 254A and 4B. FIG. 4A is a view illustrating the connecting rod 1 seen from the direction of the central axis of the crankshaft, and FIG. 4B is a sectional view taken along line IVB-IVB in FIG. 4A. The overall constitution of the connecting rod 1 according to this embodiment is the same as that of the first embodiment, except for the load dispersion constitution. Therefore, only the load dispersion constitution will now be described.

The connecting rod 1 of this embodiment is formed to have an so-called H-shaped cross section and recessed portions 42 and 43 which are formed on both side surfaces of the column 4 (surfaces extending in parallel with the rotational axis of the crankshaft).

The features of this embodiment lie on the shapes of the respective recessed portions 42 and 43.

Describing in detail, the recessed portion 42 formed at the side surface of the column 4 in the upstream rotation region, i.e., the region of the relative movement of the big end 3 to the crank pin 6 in the combustion stroke of the engine (more particularly, the region of the relative movement of the upper bearing shell 71 to the crank pin 6) has a depth larger than the recessed portion 43 formed at the side surface of the column 4 in the downstream rotation region (more particularly, the region opposite to the relative movement of the upper bearing shell 71 to the crank pin 6). Accordingly, the rigidity at the region over the column 4, the skirt 8, and the big end 3 in the upstream rotation region is lower than the rigidity at the region over the column 4, the skirt 8, and the big end 3 in the downstream rotation region.

Therefore, in this embodiment, most of the load F applied to the connecting rod 1 in the combustion stroke of the engine is transmitted to the downstream rotation region, and the load transmission to the upstream rotation region is reduced (refer to arrows on the skirt 8 in FIG. 4A).

And, load distribution applied to every point of a projected plane between the upper bearing shell 71 and the crank pin 6 in the combustion stroke of the engine is the same as that shown by the solid line in FIG. 2.

As described above, the load transmission to the region where the thickness of the oil film may be reduced in a conventional combustion stroke of the engine (the upstream rotation region) is restricted, and the pressing force of the big end 3 (more particularly, the upper bearing shell 71) against the crank pin 6 at the above region due to the explosive power F (the load) of the gas mixture is reduced. Accordingly, an oil film having sufficient thickness may be formed on the above region. On the other hand, most of the load is applied to the region opposite to the relative movement of the big end 3 to the crank pin 6 with respect to the axis line L of the connecting rod 1 (the downstream rotation region). However, because this region is the region where the oil film is originally be formed with sufficient thickness, the required oil film thickness can still be achieved in this region in this embodiment. Accordingly, the lubrication between the big end 3 of the connecting rod 1 and the crank pin 6 is improved enough to endure engine operation at high speed and power.

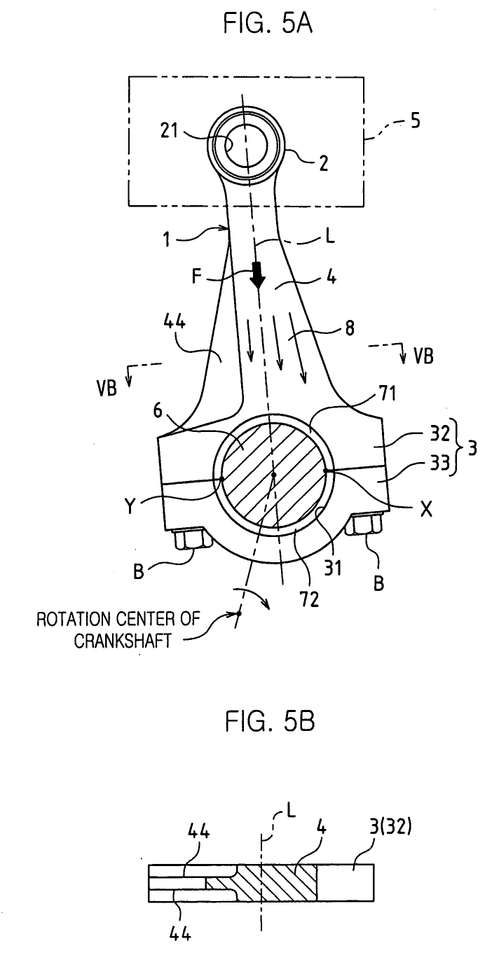

Hereinafter, a fourth embodiment will be described with reference to FIGS. 5A and 5B. FIG. 5A is a view illustrating the connecting rod 1 seen from the direction of the central axis of the crankshaft, and FIG. 5B is a sectional view taken along line VB-VB in FIG. 5A. The overall constitution of the connecting rod 1 according to this embodiment is the same as that of the first embodiment, except for the load dispersion constitution. Therefore, only the load dispersion constitution will now be described.

The connecting rod 1 of this embodiment has small-thickness portions 44 and 44 which are formed at front and rear surfaces of the column 4 (surfaces extending in a direction perpendicular to the rotational axis of the crankshaft).

The features of this embodiment lie on the position of the small-thickness portions 44 and 44.

Describing in detail, the small-thickness portion 44 is disposed only at an edge portion of the upstream rotation region, i.e., the region of the relative movement of the big end 3 to the crank pin 6 in the combustion stroke of the engine (more particularly, the region of the relative movement of the upper bearing shell 71 to the crank pin 6). In other words, the thickness of the whole downstream rotation region of the column 4 is larger than the thickness between the small-thickness portions 44 and 44. Accordingly, the rigidity at the region over the column 4, the skirt 8, and the big end 3 in the upstream rotation region is lower than the rigidity at the region over the column 4, the skirt 8, and the big end 3 in the downstream rotation region.

Therefore, in this embodiment, most of the load F applied to the connecting rod 1 in the combustion stroke of the engine is transmitted to the downstream rotation region, and the load transmission to the upstream rotation region is reduced (refer to arrows on the skirt 8 in FIG. 5A).

And, load distribution applied to every point of a projected plane between the upper bearing shell 71 and the crank pin 6 in the combustion stroke of the engine is the same as that shown by the solid line in FIG. 2.

As described above, the load transmission to the region where the thickness of the oil film is reduced in a conventional combustion stroke of the engine (the upstream rotation region) is restricted, and the pressing force of the big end 3 (more particularly, the Lipper bearing shell 71) against the crank pin 6 at the above region due to the explosive power F (the load) of the gas mixture is reduced. Accordingly, an oil film having sufficient thickness may be formed on the above region. On the other hand, most of the load is applied to the region opposite to the relative movement of the big end 3 to the crank pin 6 with respect to the axis line L of the connecting rod 1 (the downstream rotation region). However, because this region is the region where the oil film is originally formed with sufficient thickness, the required oil film thickness can still be achieved in this region in this embodiment. Accordingly, the lubrication between the big end 3 of the connecting rod 1 and the crank pin 6 is improved enough to endure engine operation at high speed and power.

The thickness between the small-thickness portions 44 and 44 is set to be about one third of the thickness of the downstream rotation region, however it may be changed. Although it is depicted in the drawing that the small-thickness portion is not formed at the downstream rotation region, the small-thickness portion may be formed with a little area at the downstream rotation region in consideration of lightweight of the connecting rod 1. This embodiment is configured such that the small-thickness portion 44 is formed over the column 4 and the skirt 8, however this is not restricted thereto. The small-thickness portion 44 may be formed from the column 4 to the big end 3.

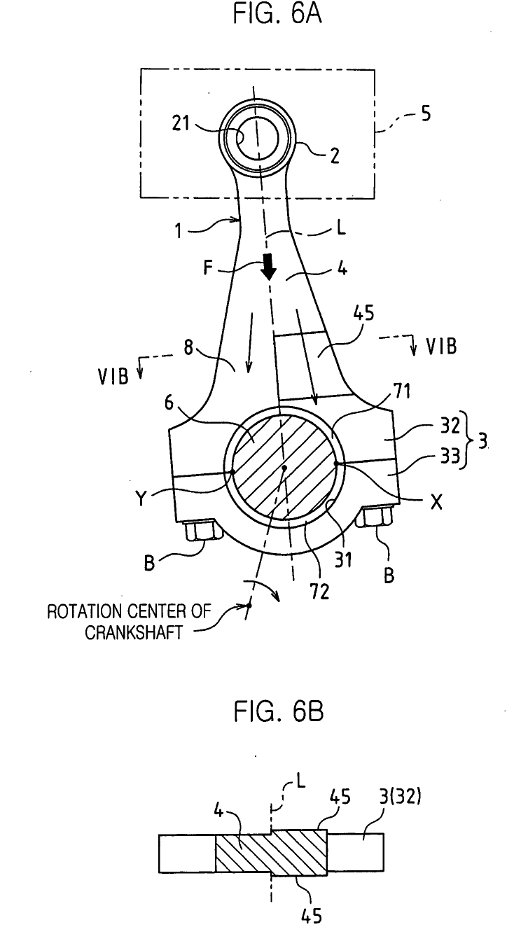

Hereinafter, a fifth embodiment will be described with reference to FIGS. 6A and 6B. FIG. 6A is a view illustrating the connecting rod 1 seen from the direction of the central axis of the crankshaft, and FIG. 6B is a sectional view taken along line I-I in FIG. 6A. The overall constitution of the connecting rod 1 according to this embodiment is the same as that of the first embodiment, except for the load dispersion constitution. Therefore, only the load dispersion constitution will now be described.

The connecting rod 1 of this embodiment has large-thickness portions 45 and 45 which are formed at the front and rear surfaces of the column 4 (surfaces extending in a direction perpendicular to the rotational axis of the crankshaft).

The features of this embodiment lie on the position of the large-thickness portions 45 and 45.

Describing in detail, the large-thickness portion 45 is disposed only at a portion of the downstream rotation region, i.e., the region opposite to the relative movement of the big end 3 to the crank pin 6 in the combustion stroke of the engine (more particularly, the region opposite to the relative movement of the upper bearing shell 71 to the crank pin 6). In other words, the thickness of the whole upstream rotation region of the column 4 is smaller than the thickness between the large-thickness portions 45 and 45. Accordingly, the rigidity at the region over the column 4, the skirt 8, and the big end 3 in the upstream rotation region is lower than the rigidity at the region over the column 4, the skirt 8, and the big end 3 in the downstream rotation region.

Therefore, in this embodiment, most of the load F applied to the connecting rod 1 in the combustion stroke of the engine is transmitted to the downstream rotation region, and the load transmission to the upstream rotation region decreases (refer to arrows on the skirt 8 in FIG. 6A).

And, load distribution applied to every point of a projected plane between the upper bearing shell 71 and the crank pin 6 in the combustion stroke of the engine is the same as that shown by the solid line in FIG. 2.

As described above, the load transmission to the region which may have the problem that the oil film is diluted in a conventional combustion stroke of the engine (the upstream rotation region) is restricted, and a pressing force of the big end 3 (more particularly, the upper bearing shell 71) to the crank pin 6 at the above region due to the explosive power F (the load) of the gas mixture is reduced. Accordingly, the oil film can be formed on the above region with a sufficient thickness. On the other hand, most of the load is applied to the region opposite to the relative movement of the big end 3 to the crank pin 6 with respect to the axis line L of the connecting rod 1 (the downstream rotation region). However, because this region is the region where the oil film can originally be formed with the sufficient thickness, the required oil film thickness can also be achieved on this region in this embodiment. Accordingly, the lubrication between the big end 3 of the connecting rod 1 and the crank pin 6 is improved enough to endure engine operation at high speed and power.

This embodiment is configured such that the large-thickness portion 45 is formed over the column 4 and the skirt 8, however this is not restricted thereto. The large-thickness portion 45 may be formed at the big end 3. Also, this embodiment is configured such that the large-thickness portion is not formed at the upstream rotation region, however the large-thickness portion may be formed with a little area at the upstream rotation region.

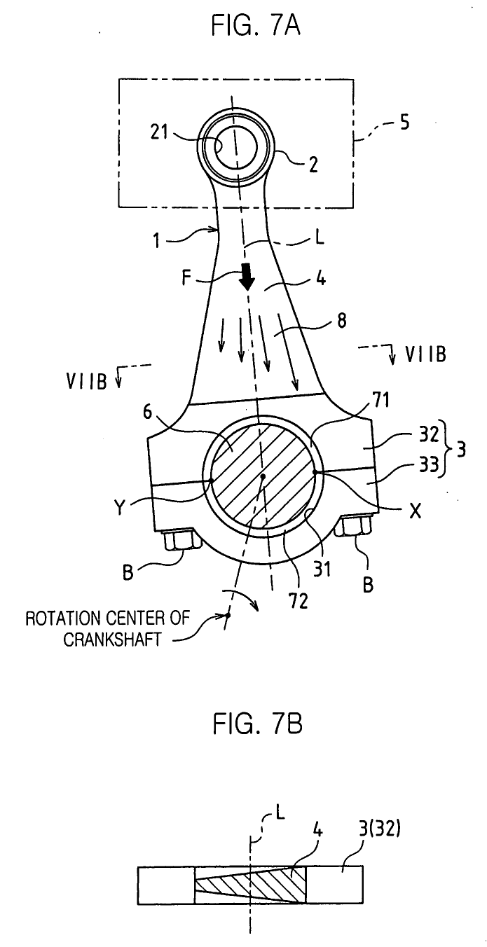

Hereinafter, a sixth embodiment will be described with reference to FIGS. 7A and 7B. FIG. 7A is a view illustrating the connecting rod 1 seen from the direction of the central axis of the crankshaft, and FIG. 7B is a sectional view taken along line VIIB-VIIB in FIG. 7A. The overall constitution of the connecting rod 1 according to this embodiment is the same as that of the first embodiment, except for the load dispersion constitution. Therefore, only the load dispersion constitution will now be described.

The connecting rod 1 of this embodiment is configured such that a thickness of the column 4 increases gradually from the upstream rotation region to the downstream rotation region. In other words, the column 4 is formed to have a substantially trapezoid-shaped cross section (refer to FIG. 7B). Accordingly, the rigidity at the region over the column 4, the skirt 8, and the big end 3 in the upstream rotation region is lower than the rigidity at the region over the column 4, the skirt 8, and the big end 3 in the downstream rotation region.

Therefore, in this embodiment, most of the load F applied to the connecting rod 1 in the combustion stroke of the engine is transmitted to the downstream rotation region, and the load transmission to the upstream rotation region decreases (refer to arrows on the skirt 8 in FIG. 7A).

And, load distribution applied to every point of a projected plane between the upper bearing shell 71 and the crank pin 6 in the combustion stroke of the engine is the same as that shown by the solid line in FIG. 2.

As described above, the load transmission to the region where the thickness of the oil film is reduced in a conventional combustion stroke of the engine (the upstream rotation region) is restricted, and the pressing force of the big end 3 (more particularly, the upper bearing shell 71) against the crank pin 6 at the above region due to the explosive power F (the load) of the gas mixture is reduced. Accordingly, an oil film having sufficient thickness may be formed on the above region. On the other hand, most of the load is applied to the region opposite to the relative movement of the big end 3 to the crank pin 6 with respect to the axis line L of the connecting rod 1 (the downstream rotation region). However, because this region is the region where the oil film is originally formed with sufficient thickness, the required oil film thickness can still be achieved in this region in this embodiment. Accordingly, the lubrication between the big end 3 of the connecting rod 1 and the crank pin 6 is improved enough to endure engine operation at high speed and power.

This embodiment is configured such that the thickness increases gradually over the column 4 and the skirt 8, however this is not restricted thereto. The thickness may be set to increase gradually from the column 4 to the big end 3.

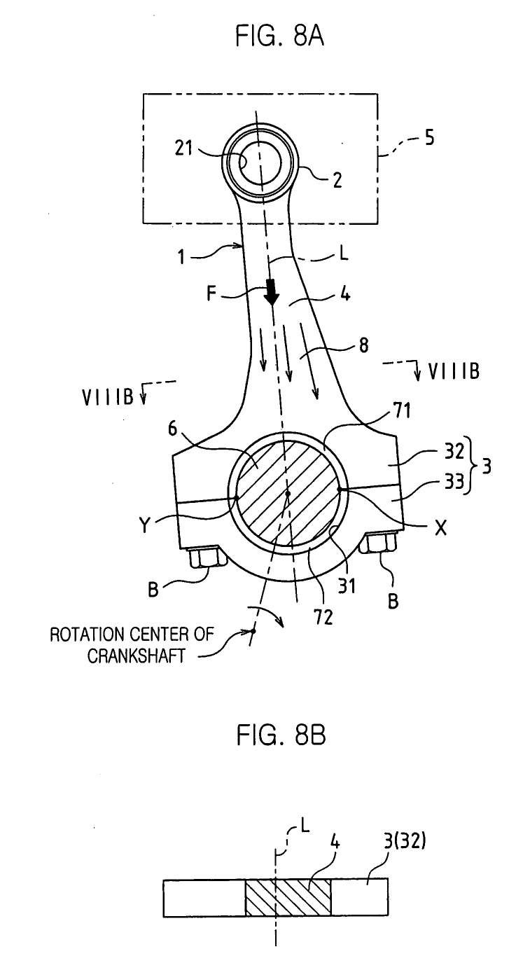

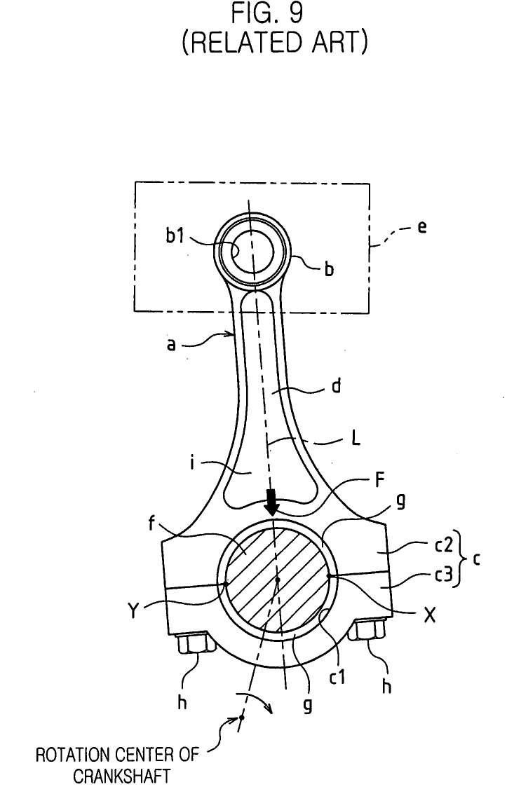

Hereinafter, a seventh embodiment will be described with reference to FIGS. 8A and 8B. FIG. 8A is a view illustrating the connecting rod 1 seen from the direction of the central axis of the crankshaft, and FIG. 8B is a sectional view taken along line I-I in FIG. 8A. The overall constitution of the connecting rod 1 according to this embodiment is the same as that of the first embodiment, except for the load dispersion constitution. Therefore, only the load dispersion constitution will now be described.

The connecting rod 1 of this embodiment has the column 4 in which the upstream rotation region has the different shape from the downstream rotation region.

Describing in detail, the edge portion of the upstream rotation region over the column 4 and the skirt 8 is cut much inwardly. Accordingly, the rigidity at the region over the column 4, the skirt 8, and the big end 3 in the upstream rotation region is lower than the rigidity at the region over the column 4, the skirt 8, and the big end 3 in the downstream rotation region.

The edge portion of the upstream rotation region over the column 4 and the skirt 8 is shaped such that the cross-sectional area of the region over the column 4 and skirt 8 (which includes both the cross-sectional area of the upstream rotation region and the cross-sectional area of the downstream rotation region) is larger than the cross-sectional area of the upper end portion of the column 4 to achieve the cross-sectional area sufficient for the transmission of the explosive power.

Therefore, in this embodiment, most of the load F applied to the connecting rod 1 in the combustion stroke of the engine is transmitted to the downstream rotation region, and the load transmission to the upstream rotation region decreases (refer to arrows on the skirt 8 in FIG. 8A).

And, load distribution applied to every point of a projected plane between the upper bearing shell 71 and the crank pin 6 in the combustion stroke of the engine is the same as that shown by the solid line in FIG. 2.

As described above, the load transmission to the region where the thickness of the oil film may be reduced in a conventional combustion stroke of the engine (the upstream rotation region) is restricted, and the pressing force of the big end 3 (more particularly, the upper bearing shell 71) against the crank pin 6 at the above region due to the explosive power F (the load) of the gas mixture is reduced. Accordingly, the oil film having sufficient thickness may be formed on the above region. On the other hand, most of the load is applied to the region opposite to the relative movement of the big end 3 to the crank pin 6 with respect to the axis line L of the connecting rod 1 (the downstream rotation region). However, because this region is the region where the oil film is originally be formed with the sufficient thickness, the required oil film thickness can still be achieved on this region in this embodiment. Accordingly, the lubrication between the big end 3 of the connecting rod 1 and the crank pin 6 is improved enough to endure engine operation at high speed and power.

In the above-described embodiments, the connecting rod 1 is shaped to be asymmetric about the axis line L of the connecting rod 1 when viewed along the rotational axis of the crankshaft (the axial view), and shaped to be symmetric about the axis line L of the connecting rod 1 when viewed from the direction perpendicular to the rotational axis of the crankshaft (the orthogonal view). However, the present invention is not restricted thereto. The connecting rod 1 may be shaped to be asymmetric about the axis line L of the connecting rod 1 in the orthogonal view. For instance, in forming the depressed portion 41, such as in the second embodiment, the connecting rod 1 may be configured such that the depressed portion 41 is formed at either the front surface or the rear surface of the column 4.

Although the embodiments when the present invention is adapted as the connecting rod 1 for a vehicle engine have been explained in the above description, the present invention may also be adapted as a connecting rod for use in other internal combustion engines.

While the invention has been shown and described with respect to the example embodiments, it will be understood by those skilled in the art that various changes and modification may be made without departing from the spirit and scope of the invention as defined in the following claims.

What is claimed is:

1. A connecting rod for an internal combustion engine, comprising:
a small end coupled to a piston;
a big end coupled to a crank pin; and
a column provided between the small end and the big end,
wherein a region of the column or a region from the column to the big end is shaped such that a rigidity of a region of relative movement of the big end to the crank pin during a combustion stroke of the internal combustion engine with respect to an axis line of the connecting rod, extending from a center point of the small end to a center point of the big end, is lower than the rigidity of a region opposite the region of relative movement.

2. The connecting rod according to claim 1, wherein a region of relative movement of the big end to the crank pin during a combustion stroke of the internal combustion engine with respect to an axis line of the connecting rod, extending from a center point of the small end to a center point of the big end, is subjected to a process to decrease rigidity, and a region opposite the region of relative movement is not subjected to the process for decreasing rigidity.

3. The connecting rod according to claim 1, wherein a region of the column or a region from the column to the big end is shaped to decrease rigidity, and an extent of decreasing the rigidity at a region of relative movement of the big end to the crank pin during a combustion stroke of the internal combustion engine with respect to an axis line of the connecting rod, extending from a center point of the small end to a center point of the big end, is higher than an extent of decreasing the rigidity at a region opposite the region of relative movement.

4. The connecting rod according to claim 1, wherein a region of relative rotation of the crank pin to the big end during a combustion stroke of the internal combustion engine with respect to an axis line of the connecting rod, extending from a center point of the small end to a center point of the big end, is subjected to a process to increase rigidity, and
a region opposite the region of relative rotation is not subjected to the process to increase rigidity.

5. The connecting rod according to claim 1, wherein a region of the column or a region from the column to the big end is shaped to increase rigidity, and an extent of increasing the rigidity at a region of relative rotation of the crank pin to the big end during a combustion stroke of the internal combustion engine with respect to an axis line of the connecting rod, extending from a center point of the small end to a center point of the big end, is higher than the extent of increasing the rigidity at a region opposite the region of relative rotation.

6. The connecting rod according to claim 1, wherein a through-hole is formed in the region of the column or the region from the column to the big end.

7. The connecting rod according to claim 2, wherein a through-hole is formed in the region of the column or the region from the column to the big end.

8. The connecting rod according to claim 1, wherein a recessed portion is formed in the region of the column or the region from the column to the big end.

9. The connecting rod according to claim 2, wherein a recessed portion is formed in the region of the column or the region from the column to the big end.

10. The connecting rod according to claim 1, wherein the region of the column or the region from the column to the big end has a narrower width from the axis line of the connecting rod than the region opposite the region of relative movement.

11. The connecting rod according to claim 2, wherein the region of the column or the region from the column to the big end has a narrower width from the axis line of the connecting rod than the region opposite the region of relative movement.

12. The connecting rod according to claim 4, wherein the region of the column or from the column to the big end is formed with a large-thickness portion.

13. The connecting rod according to claim 5, wherein the region of the column or from the column to the big end is formed with a large-thickness portion.

14. The connecting rod according to claim 3, wherein a through-hole is formed in the region of the column or the region from the column to the big end.

15. The connecting rod according to claim 3, wherein a recessed portion is formed in the region of the column or the region from the column to the big end.

16. The connecting rod according to claim 8, wherein the recessed portion is formed at a front surface and/or a rear surface of the column or the region from the column to the big end extending in a direction perpendicular to a rotational axis of the crankshaft or formed at a surface extending in a direction parallel with the rotational axis of the crankshaft.

17. The connecting rod according to claim 15, wherein the recessed portion is formed at a front surface and/or a rear surface of the column or the region from the column to the big end extending in a direction perpendicular to a rotational axis of the crankshaft or formed at a surface extending in a direction parallel with the rotational axis of the crankshaft.

18. The connecting rod according to claim 3, wherein the region of the column or the region from the column to the big end has a narrower width from the axis line of the connecting rod than the region opposite the region of relative movement.

19. The connecting rod according to claim 1, wherein the region of the column or from the column to the big end is formed with a small-thickness portion.

20. The connecting rod according to claim 1, wherein the region of the column or from the column to the big end is shaped such that a thickness increases gradually as it proceeds toward the region opposite the region of relative movement.

21. The connecting rod according to claim 1, wherein an edge portion of the column of the relative movement of the big end to the crank pin is more cut inwardly than an edge portion opposite to the relative movement to decrease the rigidity.

22. The connecting rod according to claim 1, wherein the connecting rod is formed asymmetrically such that a rigidity at a region of the column or a region from the column to the big end in a direction along which the big end moves relative to the crank pin in a combustion stroke of the internal combustion engine with respect to an axis line of the connecting rod, extending from a center point of the small end to a center point of the big end, is lower than a rigidity at a region in a direction opposite to the direction along which the big end moves relative to the crank pin in a combustion stroke of the internal combustion engine.

23. The connecting rod according to claim 1, wherein in order to decrease a load transmission to a region of relative movement of the big end to the crank pin in a combustion stroke of the internal combustion engine with respect to an axis line of the connecting rod, extending from a center point of the small end to a center point of the big end, to be lower than the load transmission to a region opposite the region of relative movement, the connecting rod is shaped such that a load peak point in the combustion stroke of is offset toward the region of relative movement with respect to the axis line of the connecting rod.
